(19) United States
(12) Patent Application Publication
(10) Pub. No.: US 2018/0184230 A1
(43) Pub. Date: Jun. 28, 2018

(54) TRAVEL SYSTEM

(71) Applicant: RENAN ROBLES, CENTEREACH, NY (US)

(72) Inventor: RENAN ROBLES, CENTEREACH, NY (US)

(21) Appl. No.: 15/392,531

(22) Filed: Dec. 28, 2016

(51) Int. Cl. H04W 4/00; H04W 4/02; H04L 29/08

(52) U.S. Cl. CPC H04W 4/001; H04L 67/02; H04W 4/025

(57) ABSTRACT

A travel system for providing and audio and visual tour guide on a smart device. The system can be paid using a subscription service, and is updated by local travel agents within a tourist area. The service can be used by tourists (local, foreign), students, and alternatively any individual interested in travel and visiting places of notoriety. Schools can also subscribe to the service for education purposes so that tours can be made available to students within a classroom setting.

### BACKGROUND OF THE INVENTION

### 1. Field of the Invention

The present invention relates generally to the field of information gathering system and more specifically relates to personal tour guide application for a smart device.

### 2. Description of Related Art

A mobile app is a computer program designed to run on smartphones, tablet computers and other mobile devices. Mobile apps were originally offered for general productivity and information retrieval, including email, calendar, contacts, and stock market and weather information. However, public demand and the availability of developer tools drove rapid expansion into other categories, such as mobile games, factory automation, GPS and location-based services, banking, order-tracking, ticket purchases and recently mobile medical apps. The explosion in number and variety of apps made discovery a challenge, which in turn led to the creation of a wide range of review, recommendation, and curation sources, including blogs, magazines, and dedicated online app-discovery services. Many new apps are desirable to provide convenient solutions to the users.

Several attempts have been made to solve the above-mentioned problems, which are herein incorporated by reference for their supportive teachings, such as those found in: U.S. Pub. No. 2013/0110633 to Julie Waldman et al.; U.S. Pat. No. 8,838,382 to John-Paul Drysdale; and U.S. Pat. No. 6,526,351 to Charles Lamont Whitham. This art is representative of information gathering. However, none of the above inventions and patents, taken either singly or in combination, is seen to describe the invention as claimed.

### BRIEF SUMMARY OF THE INVENTION

In view of the foregoing disadvantages inherent in the known information gathering system art, the present invention provides a novel Lucas—we travel together system for a smart device. The general purpose of the present invention, which will be described subsequently in greater detail is to provide a personalized digital travel assistant with directional voice commands pointing out local hot spots and points of interest while traveling in a specific area.

A Lucas—we travel together system for a smart device is disclosed herein, in a preferred embodiment, encompassing the Lucas—we travel together process including, a smart device program, a graphical user interface, a log in screen, a set of selectable menus, a set of user input parameters, a touch input recognition system, a voice input execution command recognition, a database of location information having, an internal storage medium utilization process, a WI-FI update download manger, and an auditory output decoder. The Lucas—we travel together process is enabled for use by the smart device program, the set of user input parameters, the database of location information, and the auditory output decoder. The smart device program may be installable on a tablet personal computer, smart phone, and the like. The smart device program incorporates the graphical user interface formatted for a smart device, wherein the graphical user interface has in functional combination the login screen, and the set of selectable menus for allowing a user and alternately multiple-users to input commands into the Lucas—we travel together system.

The set of user input parameters include the touch input recognition system, and the voice input execution command recognition useful for evaluating and interpreting touch and voice commands. The database of location information comprises an internal storage medium utilization process which works in conjunction with the WI-FI update download manager keeping all data up to date and stored in the smart device. The Lucas—we travel together process may be updated through a WI-FI connection allowing the smart device program to receive new program update releases, and the update releases will be used to upgrade the currently installed Lucas—we travel together process with new features and future add-ons.

The auditory output decoder may create a verbal output to the smart device speaker which may allow the user(s) to listen to important information regarding a tour. The auditory output decoder may have a set of prerecorded voice tones to allow the user to select a desirable tone when listening to provided tour information. The smart device program may use an online subscription service provided by local travel agents. The set of selectable menus may have a customizable configuration set by the local travel agents to create a user friendly experience. The online subscription service may include smart device location services for accuracy with the culture and history of the area, and the customizable configuration may detail local hot spots, and points of interests for all members of at least one travel party.

The Lucas—we travel together—process in conjunction with the smart device may be designed to record key aspects of a trip for later review and enjoyment of the user(s). The key aspects recordings may be saved via Wi-Fi to a USD storage device at the travel agent's location for later retrieval. The Lucas—we travel together process conjunction with the smart phone GPS system may include a location helper that is activated in case of emergency where the user may be lost and alternately in danger. The location helper may be programed when activated to give directions to the nearest emergency location, and alternately the location helper, when activated in case of injury, a medical team, is notified and dispatched to a specific location. The Lucas—we travel together system provides a tangible output by providing means for educating the user in local culture and history.

According to another embodiment, a method for using Lucas—we travel together system for a smart device is also disclosed herein. The method for providing a digital travel assistant with directional voice commands pointing out local hot spots and points of interest includes the steps of: programming by a travel agent, subscribing to a tour service, activating the tour service by a user(s), listening/viewing information programmed by the travel agent, and following the information as directed.

The present invention holds significant improvements and serves as a Lucas—we travel together system for a smart device. Preferably, an information gathering system should provide a digital travel assistant with directional voice commands pointing out local hot spots and points of interest and, yet would operate reliably and be manufactured at a modest expense. Thus, a need exists for a reliable Lucas—we travel together system for a smart device to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, a travel together system for a smart device, constructed and operative according to the teachings of the present disclosure.

FIG. 1 shows a perspective view illustrating a travel together system for a smart device during an ‘in-use’ condition according to an embodiment of the disclosure.

FIG. 2 is a perspective view illustrating the travel together system for a smart device comprising a Lucas—we travel together process according to an embodiment of the present invention of the disclosure.

FIG. 3 is a perspective view illustrating the travel together process according to an embodiment of the present disclosure.

FIG. 4 is a perspective view illustrating the travel together process according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an information gathering system and more particularly to a Lucas—we travel together system for a smart device as used to improve the digital travel assistant with directional voice commands for pointing out local hot spots and points of interest.

Generally speaking, the Lucas—we travel together system is an audio visual tour guide using the convenience of smart device technology which enables tourists to learn the background and history of a tourist attraction. The system can also be used as an educational tool for those individuals interested in history and alternatively science. This system allows a person to experience the tour without the need to wait for an official scheduled tour of specific sites.

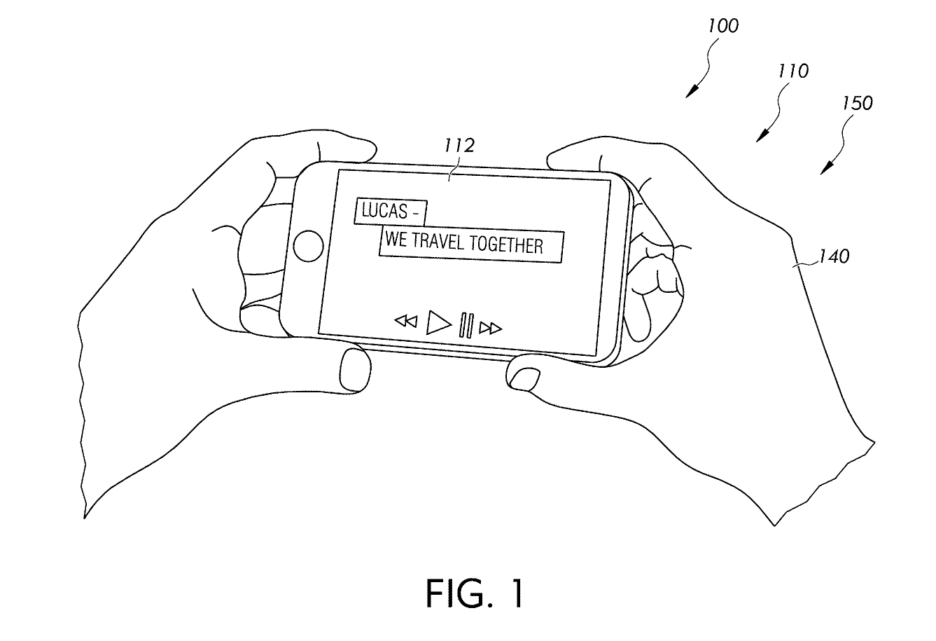

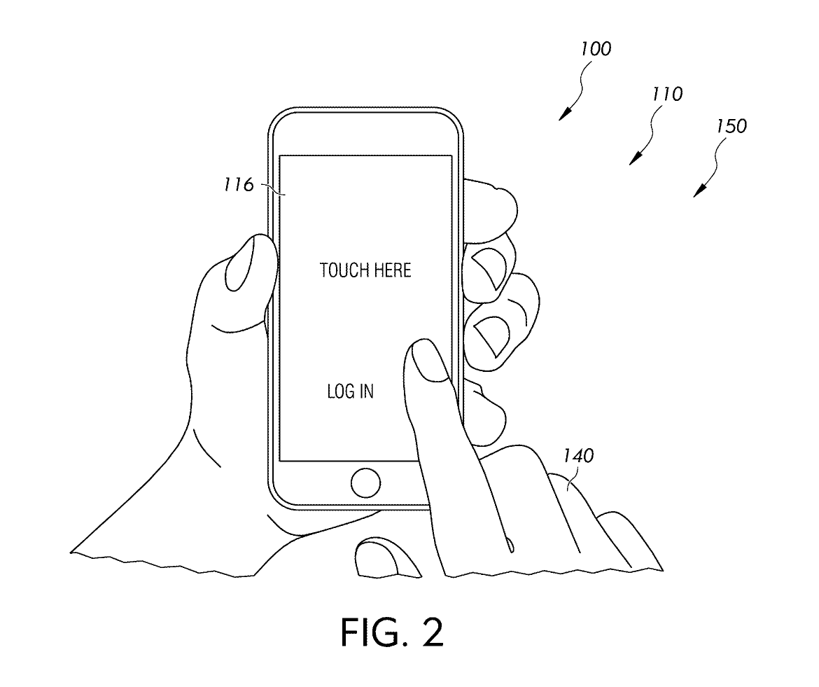

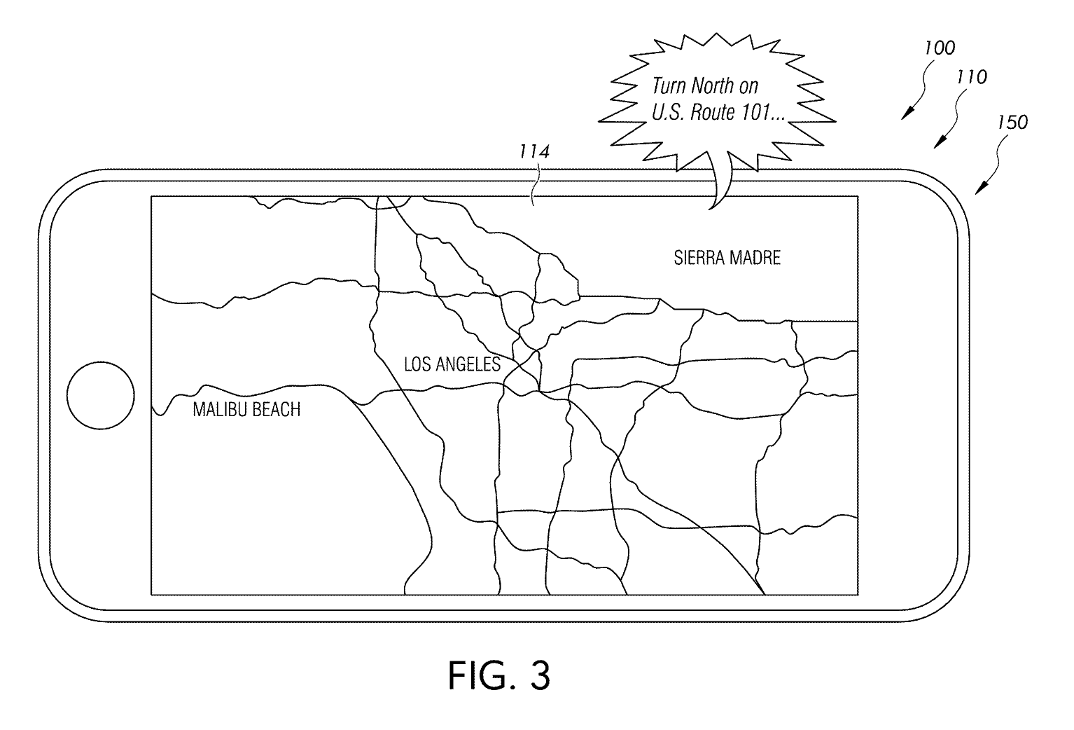

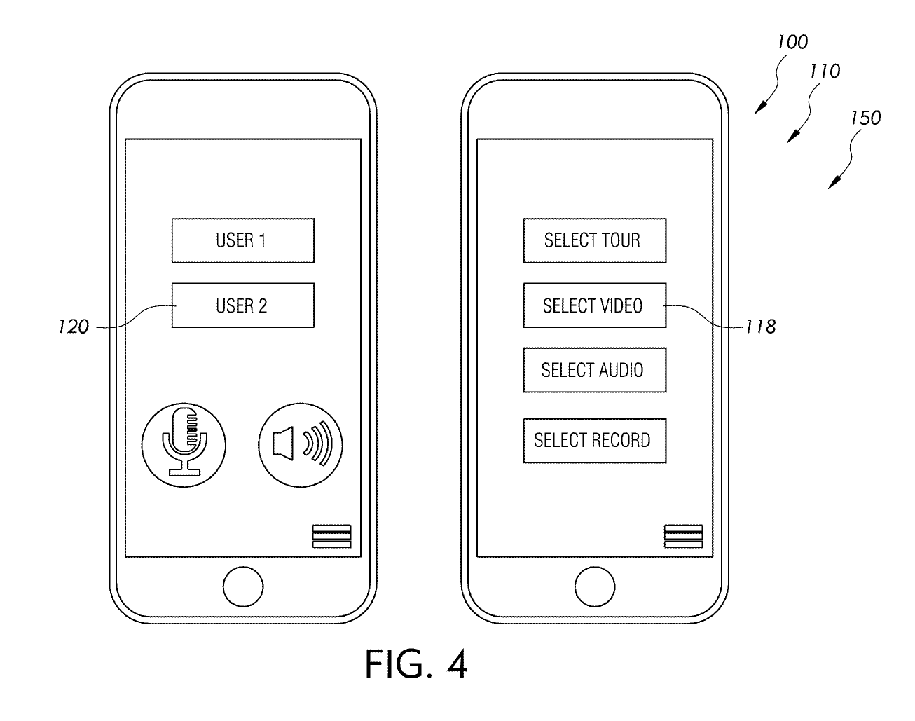

Referring now more specifically to the drawings by numerals of reference there is shown in FIGS. 1-4, various views of Lucas—we travel together system 100 comprising: Lucas—we travel together process 110 including, smart device program 112 having, graphical user interface 114 having, log in screen 116, and set of selectable menus 118, set of user input parameters 120, a touch input recognition system, and a voice input execution command recognition. The system 100 may also include a database of location information, having an internal storage medium utilization process, a WI-FI update download manager, and an auditory output decoder. Lucas—we travel together process 110 is enabled for use by smart device program 112, set of user input parameters 120, the database of location information, and the auditory output decoder.

Smart device program 112 incorporates graphical user interface 114 formatted for a smart device, wherein graphical user interface 114 has in functional combination log in screen 116, and set of selectable menus 118 for allowing a user and alternately multiple-users to input commands into the Lucas—we travel together system.

Set of user input parameters 120 include the touch input recognition system, and the voice input execution command recognition useful for evaluating and interpreting touch and voice commands. The database of location information comprises an internal storage medium utilization process which works in conjunction with the WI-FI update download manager keeping all data up to date and stored in the smart device. The auditory output decoder may create a verbal output to the smart device speaker allowing the user(s) to listen to important information regarding a tour while educating the user(s) in local culture and history.

Smart device program 112 is installable on a tablet personal computer and alternatively a smart phone. Smart device program 112 may use an online subscription service provided by local travel agents, wherein the online subscription service may include smart device location services for accuracy on the culture and history of an area. Smart device program 112, graphical user interface 114, and log in screen 116 may incorporate multiple-user log-in processes allowing for each user to save personal setting. Set of selectable menus 118 may have a customizable configuration set by local travel agents to create a user friendly experience. The customizable configuration may detail local hot spots, and points of interests for all members of at least one travel party.

Lucas—we travel together process 110 may be updateable through a WI-FI connection allowing the smart device program to receive new program update releases. The program update releases may be used to upgrade the current installation of Lucas—we travel together process 110 with new features and future add-ons. The auditory output decoder may have a set of prerecorded voice tones to allow the user to select a desirable tone when listening to provided tour information. The voice tones may use a set of recorded male tones and alternatively a set of recorded female tones.

Lucas—we travel together process 110 in conjunction with a smart phone GPS system may include a location helper that is activated in case of emergency where the user may be lost and alternately in danger. The location helper is programed when activated to give directions to the nearest emergency location. When activated in case of injury, a medical team may be notified and dispatched to a specific location. Lucas—we travel together process 110 in conjunction with a smart device may be designed to record key aspects of a trip for later review and enjoyment which may be saved via Wi-Fi to a USD storage device at the travel agent's location for later retrieval.

Lucas—we travel together system 100 may be sold as a kit comprising the following parts: at least one Lucas—we travel together process; at least one Lucas—we travel together subscription; at least one smart device; and at least one set of user instructions. The kit has instructions such that functional relationships are detailed in relation to the structure of the invention (such that the invention can be used, maintained, or the like in a preferred manner).

Lucas—we travel together system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different delivery combinations, parts may be sold separately, etc., may be sufficient.

A method of use for Lucas—we travel together system 100 may comprise the steps of: step one, programming; step two, subscribing; step three, activating; step four, listening/viewing; and step five, following.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A travel system, comprising:
a) a travel together process including:
a. a smart device program having:
i. a graphical user interface having:
1. a log in screen; and
2. a set of selectable menus;
b. a set of user input parameters;
i. a touch input recognition system; and
ii. a voice input execution command recognition;
c. a database of location information having;
i. an internal storage medium utilization process, and
ii. a WI-FI update download manger; and
d. an auditory output decoder;
wherein said travel together process is enabled for use by said smart device program, said set of user input parameters, said database of location information, and said auditory output decoder;
wherein said smart device program incorporates said graphical user interface formatted for a smart device;
wherein said graphical user interface has in functional combination said login screen, and said set of selectable menus for allowing a user to input commands into said travel together system;
wherein said set of user input parameters include said touch input recognition system, and said voice input execution command recognition useful for evaluating and interpreting touch and voice commands;
wherein said database of location information comprises an internal storage medium utilization process which works in conjunction with said WI-FI update download manager keeping all data up to date and stored in said smart device;
wherein said auditory output decoder creates a verbal output to said smart device speaker allow said user to listen to important information regarding a tour; and
wherein said travel together system provides a tangle output by educating said user in local culture and history.

2. The travel system of claim 1, wherein said smart device program is installable on a tablet personal computer.

3. The travel system of claim 1, wherein said smart device program is installable on a smart phone.

4. The travel system of claim 3, wherein said smart device program uses an online subscription service provided by locale travel agents.

5. The travel system of claim 4, wherein said online subscription service includes smart device location services for accurate said culture and history of area installation.

6. The travel system of claim 5, wherein said smart device program, said graphical user interface, and said log in screen incorporates a multiple-user log-in processes allowing for each said user to save personal setting.

7. The travel system of claim 4, wherein said set of selectable menus have a customizable configuration set by said locale travel agents to create a user friendly experience.

8. The travel system of claim 7, wherein said customizable configuration details local hot spots, and points of interests for all members of at least one travel party.

9. The travel system of claim 1, wherein said travel together process is updateable through a WI-FI connection allowing said smart device program to receive new program update releases.

10. The travel system of claim 9, wherein said program update releases will be used to upgrade installed said travel together process with new features and future add-ons.

11. The travel system of claim 1, wherein said auditory output decoder has a set of prerecorded voice tones to allow said user to select a desirable tone.

12. The travel system of claim 11, wherein said voice tones use a set of recorded male tones.

13. The travel system of claim 11, wherein said voice tones use a set of recorded female tones.

14. The travel system of claim 1, wherein said travel together process conjunction with a said smart phone GPS system includes a location helper that is activated in case of emergency where said user may be lost and alternately in danger.

15. The travel system of claim 14, wherein said location helper is programmed when activated to gives directions to a nearest emergency location.

16. The travel system of claim 15, wherein said location helper when activated in case of injury a medical team is notified and dispatched to a specific location.

17. The travel system of claim 1, wherein said travel together process in conjunction with a said smart device is designed to record key aspects of a trip for later review and enjoyment.

18. The travel system of claim 17, wherein said key aspects recordings and saved via WiFi to USD storage device at said travel agent's location for later retrieval.
